(19) United States
(12) Patent Application Publication
(10) Pub. No.: US 2007/0199058 A1
(43) Pub. Date: Aug. 23, 2007

(54) Method of using a security token

(75) Inventors: Rainer Hans Friedrich Baumgart, Hilchenbach (DE); Uwe Demsky, Schwerte (DE); Kai Martius, Dorfhain (DE); Matthias Besch, Munchen (DE)

Correspondence Address: K.F. ROSS P.C., 5683 RIVERDALE AVENUE, SUITE 203 BOX 900, BRONX, NY, 10471-0900, US

(73) Assignee: secunet SECURITY NETWORKS Aktiengesellschaft

(21) Appl. No.: 11/703,603

(22) Filed: Feb. 7, 2007

(30) Foreign Application Priority Data
Feb. 10, 2006 (EP) 06002770.3

(51) Int. Cl. H04L 9/32

(52) U.S. Cl. 726/9

(57) ABSTRACT

A security token is scanned by a pure reader that is connected to a computer. This immediately loads from the token into the computer a virtual machine having a virtual operating system. Then an identification/authentication code is entered via a peripheral of the computer, whereupon data can be exchanged between the security token and the virtual operating system, and thence exchanged between the virtual operating system and a remote location.

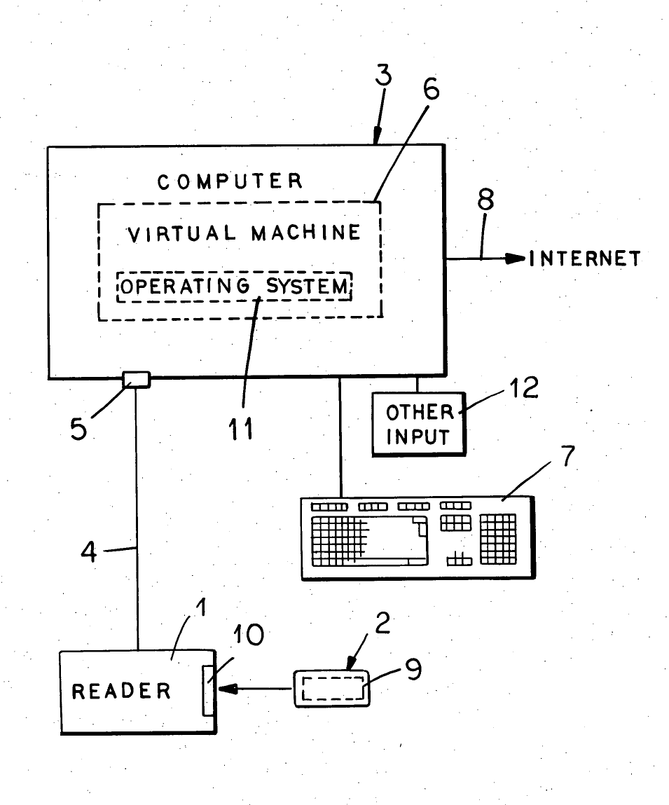

### FIELD OF THE INVENTION

The present invention relates to a security token. More particularly this invention concerns a method of using a security token.

### BACKGROUND OF THE INVENTION

A security token is a physical. device on which information or data, normally in digital form, is stored and that is so set up that the data can only be read, or any programming in the information can be executed once a specific identification/authentication process has been completed. The term covers USB sticks, hardware tokens, authentication tokens, and cryptographic tokens.

The use of security tokens, in particular chip cards, has been known for some time in actual practice, in particular the use of chip cards for internet banking a chip card is inserted into a reader, and the user must enter an authentication code via an input unit, e.g. a keyboard. The. secret or confidential information that is entered, in particular in the form of a personal information number (PIN), is relayed to the chip card and verified thereby.

When the input unit or keyboard is not directly connected to the reader, and thus not directly connected to the chip card, there is a risk that the confidential information could be seen or read by third parties on its way to the input unit for the reader. confidential information may be lost due to manipulation of input units, defective or altered software (Trojan horses), or the like. For security reasons, therefore, readers for chip cards are used in practice that generally contain both an input unit (keyboard or keypad) and a display device integrated therein. These readers are of complicated design and are relatively costly.

### OBJECTS OF THE INVENTION

It is therefore an object of the present invention to provide an improved method of using a security token.

Another object is the provision of such an improved method of using a security token that overcomes the above-given disadvantages, in particular that can be carried out in a functionally reliable manner, and above that all meets all security requirements and is still economical to implement.

### SUMMARY OF THE INVENTION

A method of using a security token. The method has according to the invention the step of scanning the security token with a reader connected to a computer, temporarily loading into the computer a virtual machine (VM) having a virtual operating system, entering an identification/authentication code via a peripheral or input unit into the computer, and thereafter exchanging data between the security token and the virtual operating system.

Within the scope of the invention, the reader and the peripheral device for the computer are different devices. According to one embodiment, the identification/authentication code is entered via a keyboard in the form of a numerical and/or a letter code and/or in the form of another character code. Other possibilities for the identification/authentication code are discussed in greater detail below.

Within the scope of the invention, a virtual machine refers to a system or a computer program that emulates a virtual computer on an existing computer. The virtual machine to be installed on the computer provides a separate system platform for the token-reading application. Such a virtual machine represents a self-sufficient operating environment that is essentially independent of the actual computer system and its commercial operating system. In this manner effective protection may be provided against faulty configurations, viruses, Trojan horses, and the like. Within the scope of the invention, the virtual machine is available only for interaction or data exchange with the security token. The virtual machine encompasses a virtual operating system (guest operating system) and in particular a token-reading program or token-reading routine. The virtual operating. system is decoupled, in a manner of speaking, from the actual operating system of the computer. Virtual machines (VM) as such are known to those skilled in the art. The invention is based on the finding that such a virtual machine is optimally suited for the secure use of a security token.

The security token is in data transmission connection with the reader. Within the scope of the invention, the security token is inserted into the reader. In particular, a chip card is inserted into a reader, which for this purpose has an insertion slot designed in a known manner. The reader is in data transmission connection with the computer according to one embodiment, the reader is connected to the USB port of the computer, for example, via a cable according to a further embodiment, the reader is in wireless connection with the computer. The corresponding data are thus transmitted via radio link. The security token may also be inserted directly into the computer or into the USB port of the computer. This is the case, for example, when the security token is a USB stick that is inserted into the USB port of the computer. In such embodiments, the reader is integrated into the token, and thus via the USB connector is integrated into the computer.

Within the scope of the invention, the reader is a so-called pure reader and does not have a display device or an input unit a display device is understood to mean primarily a display or screen on which the entered identification/authentication code in particular may be displayed. It is therefore a feature of the invention that the reader does not have such a display device. The term “input unit” refers primarily to a keypad or keyboard by means of which the identification/authentication code in particular is entered, although fingerprint/retina scanners are known. It is therefore within the scope of the invention that the reader according to the invention does not have such an input unit or input keyboard. It is practical for the reader to be equipped only with the components that are necessary for reading the security token and for relaying the read data. These components must in particular provide the operating voltage, and ensure the reading function and the function of at least one communication interface. The reader according to the invention can be USB or battery powered relatively easily.

It has been noted above that according to one embodiment of the invention, the identification/authentication code is entered as an alphanumeric code. However, a code comprising any set or alphabet of characters may also be entered. It is practical for the identification/authentication code to be entered via keys to which numbers, letters, or other characters are assigned.

According to one preferred embodiment of the invention, the identification/authentication code is entered via the keyboard associated with the computer. The input unit or the corresponding peripheral device for the computer is thus a conventional computer keyboard that is associated with the computer on which the virtual machine is installed. It is within the scope of the invention for additional entries that are desired or necessary with regard to use of the security token to be entered via this computer keyboard.

According to a further preferred embodiment of the invention, the identification/authentication code is entered via an input unit that is virtually generated on a display device for the computer. It is within the scope of the invention for additional entries that are desired or necessary with regard to use of the security token to be entered via this virtual input unit. It is practical for the display device to be the monitor or screen for the computer. The virtually generated input unit is preferably a keyboard that is virtually generated on the display device or the monitor. It is expedient to select the keys on the virtually generated keyboard by use of an input device for the computer, in particular by means of a mouse click. According to one preferred embodiment of the invention, the configuration of the virtual keys may be selected at random, i.e. by use of a random generator, each time the virtual input unit is generated. It is also within the scope of the invention for the configuration of the keys for the virtual input device to be randomly regenerated at specified time intervals.

According to one embodiment of the invention, the identification/authentication code is entered in the form of biometric data via a bioentry unit connected to the computer a bioentry unit refers to a device for detecting biometric data or for detecting biometric information for the particular user. Thus, in this embodiment the bioentry unit is the peripheral device for the computer via which the code is entered according to one embodiment variant, the biometric-data entry unit is a fingerprint reader that is able to detect the fingerprint of a user and relay the corresponding data or information to the connected computer or to the virtual operating system on the computer. In this case, the identification/authentication code is thus composed of the data/information concerning the user's fingerprint. In this embodiment, the other entries may be performed via another peripheral device for the computer, preferably via one of the input units described above.

According to one particularly preferred embodiment of the invention, any other use of the peripheral device during an identification/authentication phase is blocked by the virtual machine. In other words, the input unit, for example the keyboard, is available only for use by the security token and is blocked for other uses. It is possible to perform this blocking or reservation of the input unit by use of software in the virtual operating system or the virtual machine.

It is within the scope of the invention for the entry of the identification/authentication code and any other entries to be handled/processed solely by the virtual machine or the virtual operating system. It is also within the scope of the invention for only the virtual machine or the virtual operating system to be able to relay data to the security token, and/or to read from the security token, and/or to relay data to a higher-level control center or to a central computer.

It is recommended that data encrypted by use of a cryptographic method be transmitted from the virtual-machine or the virtual operating system to the security token. Such cryptographic methods are known as such. In this manner, very secure data transmission is ensured within the scope of the invention. It is further recommended that data encrypted by use of a cryptographic method be transmitted from the security token, to the virtual machine or the virtual operating system. Within the scope of the invention, great importance is attached to the cryptographically protected data communication. The transmission of data encrypted by use of a cryptographic method is particularly important when data from the reader are to be transmitted over long distances to the computer a secure messaging channel based on symmetrical cryptography may be established to perform the cryptographically protected communication. Malicious software (malware) that may be present outside the virtual-machine in the commercial operating system of the computer that is communicating with the security token is thus prevented, for example, from intercepting and rerouting the data communication. In this manner effective protection may be provided against faulty configurations, viruses, Trojan horses, and the like.

One special embodiment of the invention is characterized in that the virtual machine or the virtual operating system is loaded from the security token onto the computer. In other words, the security token contains the software that is necessary for installation of the virtual machine or the virtual operating system. This software is then loaded from the security token onto the computer. Thus, the software is located, for example, on a chip card used as a security token.

The invention is based on the finding that a very secure input and output, i.e. display of data/information, is possible by use of the method according to the invention. by use of the virtualization technique on a standard home or office personal computer, a token-reading or chip card reading application may be securely partitioned from other applications that are not intended for use by the security token a very high degree of security is achieved by-the virtualization according to the invention all input and output functions necessary for the use of the security token are preferably controlled by the virtual machine. The invention is based on the further discovery that a reader having complicated input and output units for the input or output of data is not needed. Rather, by use of the virtualization technique according to the invention an economical reader may be used that does not have complicated input and output units. In this respect, the invention is based on the finding that the input and output units on the known readers are actually superfluous, since a commercially available computer connected to the reader already has input and output components, i.e. a display that may be used with the assistance of the virtualization technique according to the invention to ensure a high degree of security. In this respect, the invention allows the very advantageous use of security tokens with economical hardware.

### BRIEF DESCRIPTION OF THE DRAWING

The above and other objects, features, and advantages will become more readily apparent from the following description, reference being made to the accompanying. drawing whose sole FIGURE is a schematic diagram illustrating the instant invention.

### SPECIFIC DESCRIPTION

As seen in the drawing, a device for carrying out the method according to the invention for using security tokens 2 has a card scanner or reader 1 that is placed in data-transmission connection with a chip card forming a security token 2 by insertion of the chip card 2 into a slot 10 of the reader 1, as shown by the arrow. The reader 1 is in data transmission connection with a computer 3 via a cable 4 plugged into a USB port 5 of the computer 3. The data could also be transmitted from the reader 1 to the computer 3 without a cable, i.e. wireless. The reader 1 can be an extremely small device that could be carried in a pocket and that is USB powered so that it can travel, if necessary, with the user of the card 2.

A virtual machine 6 comprising a virtual operating system 11 is temporarily loaded into the computer 3 an identification/authentication code that can be alphanumeric is entered via the keyboard 7 for the computer 3, although another input unit 12 could be used that is, for instance a fingerprint reader, a retina scanner, or the like. It is then possible for data exchange to take place between the chip card 2 and the virtual machine 6 or its virtual operating system 11, bypassing any spyware or the like that might be in the computer 3. Connection 8 is a line to the internet for the computer 3. The computer 3 is connected in particular to a central computer, such as the central computer of a bank, via the internet connection 8. Of course, the software at the remote bank. is able to deal directly with the virtual machine 6 in whatever exotic encryption mode is employed.

One particularly preferred embodiment of the invention is the use of the method according to the invention for internet banking. In this case, a chip card preferably designed as a bank card is used as a security token. The bank customer may use a simple, inexpensive reader, not equipped with an input unit (keypad or keyboard) or display device, for this chip card, for instance a pocket-sized portable unit. The bank customer may then connect this reader to a conventional computer, anything with a USB port and using a recognizable operating system.

The virtual machine is according to the invention a self-loading install program 9 on the chip card 2 that autoexecutes and installs when scanned. This program is loaded from the chip card 2 onto the computer as the card 2 is scanned, and the bank customer then conducts internet banking according to the method described above with the advantages according to the invention, the bank customer may conduct internet banking using economical hardware while at the same time ensuring a high degree of security. Phishing confidential authentication data may be effectively prevented by use of the method according to the invention. Of course, the virtual machine exists only in RAM in the local host computer and turns control of the unit back over to its native operating system and self destructs by autoerasure normally the instant the card reader 1 is disconnected. Thus as soon as the connection at the USB port 5 is broken, the machine 6 and its operating system 11 vanish.

The method according to the invention may also be used for a web-based application. The use of the method according to the invention is of particular importance for digital signatures. It may be used in a very secure manner for electronically signing a document. For the statement of intent for the signature, the particular document is displayed, in particular on the monitor of the computer, and the signature process is started by entering the identification/authentication code. In this application as well, manipulated display of the document to be signed, or “exploration” of confidential authentication data, may be effectively prevented.

We claim:

1. A method of using a security token, the method comprising the step of:
scanning the security token with a reader connected to a local computer;
temporarily loading into the local computer a virtual machine having a virtual operating system;
entering an identification/authentication code via an input unit into the local computer; and
thereafter exchanging data between the security token and the virtual operating system.

2. The method defined in claim 1 wherein the security token is scanned by being inserted into a slot of the reader.

3. The method defined in claim 1 wherein the reader does not have a display.

4. The method defined in claim 1 wherein the reader does not have an input device.

5. The method defined in claim 1 wherein the peripheral is a keyboard of the local computer.

6. The method defined in claim 1 wherein the identification/authentication code is inputted via a virtual input device of the local computer.

7. The method defined in claim 1 wherein the peripheral is a biometric scanner.

8. The method defined in claim 7 wherein the scanner is a fingerprint scanner.

9. The method defined in claim 1 wherein the virtual machine blocks use of the peripheral during an identification/authentication phase.

10. The method defined in claim 1 wherein the cryptographically keyed data is transmitted by the virtual machine to the security token.

11. The method defined in claim 1 wherein cryptographically keyed data is transmitted by the security token to the virtual machine.

12. The method defined in claim 1 wherein the virtual machine and operating system are loaded by the security token onto the local computer.

13. The method defined in claim 12, further comprising the step of
providing the security token with a self-loading install program capable of autoloading the virtual machine and virtual operating system, the virtual machine and operating system being loaded onto the local computer by the security token as the card is scanned.

14. The method defined in claim 1, further comprising the steps of:
encrypting the data through the virtual operating system; and
exchanging the encrypted data through network with another computer capable of communicating with the local computer and of decrypting the data.

15. The method defined in claim 1 further comprising the step of:
creating by means of the virtual operating system on a display of the local computer a virtual mouse-selectable keyboard and using it as the input unit.
